(19) United States
(12) Patent Application Publication
(10) Pub. No.: US 2009/0303167 A1
(43) Pub. Date: Dec. 10, 2009

(54) Liquid Crystal Display Device

(75) Inventors: Ikuko Mori, Mobara (JP); Yasuyuki Kudo, Nakano (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/480,796

(22) Filed: Jun. 9, 2009

(30) Foreign Application Priority Data
Jun. 9, 2008 (JP) 2008-150605

(51) Int. Cl. G09G 3/36

(52) U.S. Cl. 345/89; 345/102

(57) ABSTRACT

A liquid crystal display device which can enhance power-consumption reduction efficiency irrespective of inputted image data is provided. The liquid crystal display device includes: a liquid crystal display panel which includes a display region formed of a mass of a plurality of pixels; a backlight which has a plurality of light sources receiving a lighting control independently, and has a region thereof where the light sources are mounted partitioned into a plurality of lighting regions; and a control circuit which converts image data inputted from the outside into a video signal to be supplied to the liquid crystal display panel and performs the lighting control of the backlight, wherein the control circuit forms a first frame in which image data having a grayscale higher than a grayscale of image data to be displayed is formed and a second frame in which image data having a grayscale lower than a grayscale of the image data to be displayed are formed, and alternately displays the image data in the first frame and the image data in the second frame, and the backlight performs the lighting control for every lighting region of the backlight in conformity with a display content of the liquid crystal display panel.

The present application claims priority from Japanese application JP2008-150605 filed on Jun. 9, 2008, the content of which is hereby incorporated by reference into this application.

### BACKGROUND OF THE INVENTION

1. Field of the Invention

The present invention relates to a liquid crystal display device, and more particularly to a liquid crystal display device which can perform driving of a liquid crystal display panel and a backlight suitable for a motion picture display.

2. Description of the Related Art

A large-sized liquid crystal display device used in a television receiver set or the like includes, in general, a backlight which has a light source on a back surface of a liquid crystal display panel. That is, the liquid crystal display device includes a so-called direct backlight. In the liquid crystal display panel, a plurality of pixels are arranged on a display region in a matrix array, and with a control of grayscales of respective pixels, a viewer can recognize an image by light of the backlight radiated through respective pixels of the liquid crystal display panel.

As a light source of a large-sized backlight for a television receiver set or the like, a fluorescent lamp which constitutes a linear light source such as a CCFL or an EEFL is used in general. On the other hand, recently, a light emitting diode which is referred to as LED has been also proposed.

Brightness of a pixel of a liquid crystal display panel perceived through light from a backlight has the following relationship.

Brightness of pixel=optical transmissivity (grayscale) of pixel of liquid crystal display panel×brightness of direct backlight light source.

When the linear light sources such as the fluorescent lamps are used, even when brightness of the backlight is controlled, such a control can be performed only for every fluorescent lamp and hence, brightness can be controlled only in one direction resulting in a one-dimensional brightness control.

To the contrary, when a plurality of light emitting diodes is arranged on a liquid crystal display panel in a matrix array in a state that these light emitting diodes overlap with the liquid crystal display panel, brightness of a backlight can be controlled two-dimensionally. Such a backlight control method is referred to as a local dimming method (see JP-A-2007-183608 (corresponding US patent publication US 2007/0152926A1) (patent document 1)), and this method contributes to the enhancement of a dynamic contrast of a display image.

### SUMMARY OF THE INVENTION

Recently, an environmental problem becomes crucial and hence, a liquid crystal display device is also requested to satisfy a demand for low power consumption.

In case of a liquid crystal display device, the power consumption of a backlight occupies a large percentage and hence, the backlight is considered as a target whose consumption of power is reduced as much as possible. However, even when the above-mentioned local dimming method is adopted, the reduction of power is not guaranteed. The reason is as follows. That is, a control of brightness of the backlight depends on image data necessary for displaying an image on a liquid crystal display panel. With respect to the liquid crystal display panel of a television receiver set or the like, although image data is inputted at a frame period of 60 Hz or 120 Hz, the inputted image data largely varies and hence, the inputted image data is constantly changed depending on an intention of a user.

Accordingly, it is an object of the present invention to provide a liquid crystal display device which can enhance power-consumption reduction efficiency irrespective of inputted image data.

To briefly explain the summary of typical inventions among inventions disclosed in this specification, they are as follows.

(1) According to one aspect of the present invention, there is provided a liquid crystal display device including: a liquid crystal display panel which includes a display region formed of a mass of a plurality of pixels; a backlight which has a plurality of light sources receiving a lighting control independently, and has a region thereof where the light sources are mounted partitioned into a plurality of lighting regions; and a control circuit which converts image data inputted from the outside into a video signal to be supplied to the liquid crystal display panel and performs the lighting control of the backlight, wherein the control circuit forms a first frame in which image data having a grayscale higher than a grayscale of image data to be displayed is formed and a second frame in which image data having a grayscale lower than a grayscale of the image data to be displayed are formed, and alternately displays the image data in the first frame and the image data in the second frame, and the backlight performs the lighting control for every lighting region of the backlight in conformity with a display content of the liquid crystal display panel.

(2) In the liquid crystal display device of the present invention having the constitution (1), the light sources of the backlight may be light emitting diodes.

(3) In the liquid crystal display device of the present invention having the constitution (2), the light emitting diodes may be arranged in a matrix array at positions where the light emitting diodes overlap with the liquid crystal display panel.

(4) In the liquid crystal display device of the present invention having the constitution (2), the plurality of lighting regions is partitioned in a check pattern on a substrate of the backlight.

(5) In the liquid crystal display device of the present invention having the constitution (2), the plurality of light emitting diodes is arranged in the lighting regions.

(6) In the liquid crystal display device of the present invention having the constitution (1), brightness of the light source of the backlight is controlled in conformity with input grayscales of the respective image data in the first frame and the second frame.

The present invention is not limited to the liquid crystal display device having the above-mentioned constitutions and various modifications can be made without departing from the technical concept of the present invention. Further, constitutional examples other than the above-mentioned constitutions will become apparent from the description of the whole specification and drawings.

The liquid crystal display device having such constitutions can enhance the power consumption reduction efficiency irrespective of data to be inputted. Other advantageous effects of the present invention will become apparent from the whole specification.

### BRIEF DESCRIPTION OF THE DRAWINGS

FIG. 1 is a view showing one embodiment of a liquid crystal display device according to the present invention, wherein a drive state of a liquid crystal display panel and a backlight in a bright field and a dark field is shown;

FIG. 2 is a block diagram showing a control circuit of the liquid crystal display device according to the present invention;

FIG. 3 is a view showing the constitution of a module of the liquid crystal display device according to the present invention;

FIG. 4 is a plan view showing one embodiment of a backlight of the liquid crystal display device according to the present invention;

FIG. 5A and FIG. 5B are views for explaining an FBI method;

FIG. 6A to FIG. 6C are views for explaining one example of driving of the liquid crystal display device according to the present invention;

FIG. 7A to FIG. 7C are views showing a comparison example which is compared with the present invention;

FIG. 8A to FIG. 8C are views showing a comparison example which is compared with the present invention; and

FIG. 9A to FIG. 9C views showing a comparison example which is compared with the present invention.

### DESCRIPTION OF THE PREFERRED EMBODIMENTS

Embodiments of the present invention are explained in conjunction with drawings. Here, in all embodiments and drawings, identical or similar constitutional elements are given same symbols, and their repeated explanation is omitted.

### Embodiment 1

### (Whole Constitution)

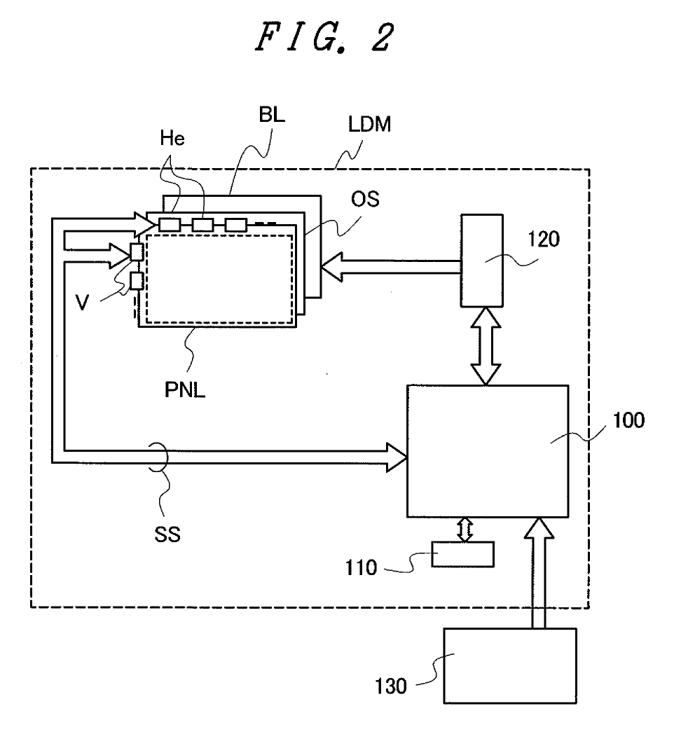

FIG. 2 shows one embodiment of the whole constitution of the liquid crystal display device LDM according to the present invention. As the liquid crystal display device LDM, a liquid crystal display device which is used in a liquid crystal television receiver set or the like is exemplified, for example.

In FIG. 2, the liquid crystal display device (module) LDM is constituted of a liquid crystal display panel PNL, an optical sheet OS, a backlight BL, a display control circuit (T-Con substrate) 100, a memory 110, and an inverter circuit 120. Here, the backlight BL forms a plurality of light emitting diodes in a scattered manner on a surface thereof which faces the liquid crystal display panel PNL in an opposed manner, for example.

Further, FIG. 2 also shows an image processing engine 130 which constitutes an external system of the liquid crystal display device LDM. The image processing engine 130 is a circuit which generates image data for allowing the liquid crystal display device LDM to display an image in response to received broadcasting waves on a liquid crystal television receiver set.

Although not shown in the drawing, the display control circuit 100 includes a CPU, an input/output port and the like. The memory 110 stores various programs including a display program for generating display data for performing a display on a liquid crystal display panel PNL based on image data inputted from the image processing engine 130, and a program for controlling turning on and off of respective light emitting diodes of the backlight BL based on the display data for every group of the light emitting diodes.

Further, the display control circuit 100 inputs the generated display data to a scanning signal drive circuit V and a video signal drive circuit He of the liquid crystal display panel PNL as a display drive signal SS. Due to such an operation, an image is displayed on a display region AR of the liquid crystal display panel PNL.

Further, the display control circuit 100 controls turning on/off of the light emitting diodes of the backlight BL via an inverter circuit 120. Here, turning on/off of the light emitting diodes may be performed for every group of light emitting diodes based on the program stored in the memory 110.

### (Schematic Constitution of Liquid Crystal Display Panel PNL and Backlight BL.)

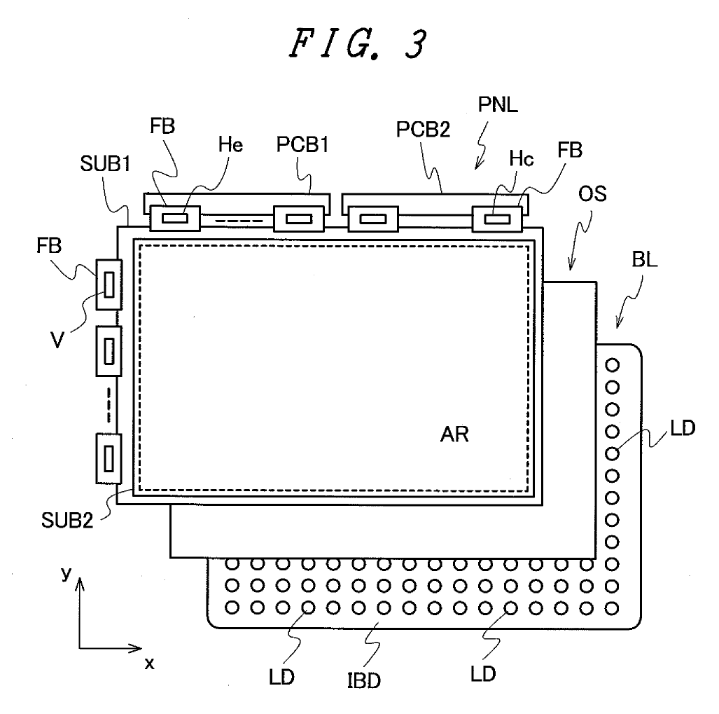

FIG. 3 is an exploded plan view showing one embodiment of the liquid crystal display panel PNL and the backlight BL of the liquid crystal display device LDM. The liquid crystal display panel PNL is arranged on a viewer's side, and a sheet OS and a backlight BL are sequentially arranged behind the liquid crystal display panel PNL.

The liquid crystal display panel PNL is formed of an envelope which includes a pair of parallel-arranged substrates SUB1, SUB 2 made of glass, for example, and liquid crystal is sandwiched between these substrates SUB1, SUB2. On liquid-crystal-side surfaces of the substrates SUB1, SUB2, pixels (not shown in the drawing) which are arranged in a matrix array are formed using the liquid crystal as one constitutional element, wherein optical transmissivity is controlled for every pixel. A region in which these respective pixels are formed is defined as a display region AR (a region surrounded by a chained-line frame in the drawing), and a viewer can recognize an image through light from the backlight BL in the display region AR.

The substrate SUB1 includes, for example, portions which are exposed from the substrate SUB2 on a left side and an upper side in the drawing, and one side of a plurality of flexible printed circuit boards FB is connected to these portions. On these flexible printed circuit boards FB, video signal drive circuits He, and scanning signal drive circuits V for individually or independently driving the respective pixels are formed. On the flexible printed circuit boards FB which are arranged to parallel to each other in the x direction in the drawing, the video signal drive circuit He is formed. With respect to the flexible printed circuit boards FB on which the video signal drive circuit He is formed, printed circuit boards PCB1, PCB2 are connected to another side of the flexible printed circuit boards FB opposite to one side of the flexible printed circuit boards FB to which the substrate SUB1 is connected. Video signals are inputted to the pixels from the display control circuit 100 (see FIG. 2) via the printed circuit boards PCB1, PCB2. In the liquid crystal display device of this embodiment, for example, two printed circuit boards PCB1, PCB2 are arranged. Further, on the flexible printed circuit boards FB which are arranged in parallel in the y direction in the drawing, scanning signal drive circuit V is formed. To the flexible printed circuit boards FB on which the scanning signal drive circuits V is formed, input signals from the display control circuit 100 are inputted to the pixels via lines (not shown in the drawing) formed on surfaces of the printed circuit boards PCB 1 and the substrate SUB 1. Printed circuit boards which correspond to the printed circuit boards PCB1, PCB 2 are not connected to the flexible printed circuit boards FB arranged in parallel in the y direction.

On a back surface of the liquid crystal display panel PNL, the backlight BL is arranged by way of the optical sheet OS formed of, for example, a diffusion sheet, a prism sheet or a stacked body of these sheets. The optical sheet OS guides light from the backlight BL to the liquid crystal display panel PNL after diffusing or condensing light.

The backlight BL is formed by arranging a plurality of light emitting diodes LD in a matrix array on a surface of an insulation substrate IBD which is arranged to face at least the display region AR of the liquid crystal display panel PNL in an opposed manner. The plurality of light emitting diodes LD are formed as a surface light source and the surface light source radiates white light to the liquid crystal display panel PNL side.

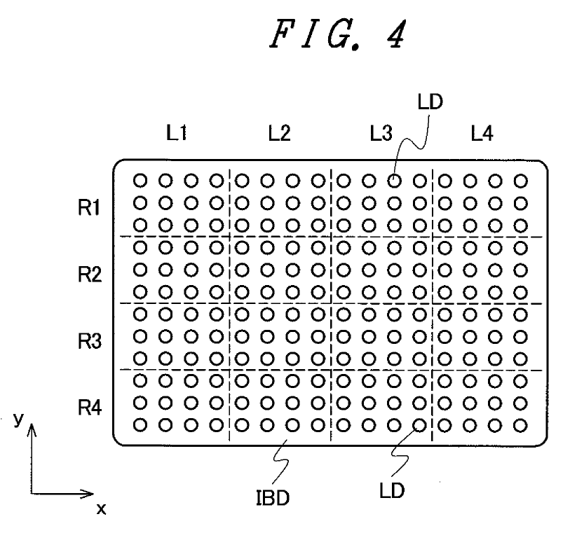

FIG. 4 shows the back light BL by only extracting the back light BL from the liquid crystal display panel PNL. As shown in FIG. 4, the respective light emitting diodes LD are divided into regions in which the light emitting diodes LD are formed (indicated by a dotted line in the drawing). For example, the light emitting diodes LD are divided into 16 groups (4×4), and turning on/off of the respective light emitting diodes LD is controlled independently for every group. That is, assuming respective rows in the division of light emitting diodes LD as R1, R2, R3, R4 from above in the drawing, and assuming respective columns in the division of the light emitting diodes LD as L1, L2, L3, L4 from a left side in the drawing, the respective light emitting diodes belong to any one of groups (R1, L1), (R1, L2), (R1, L3), (R1, L4), (R2, L1), (R2, L2), . . . , (R4, L2), (R4, L3), and (R4, L4). Due to such constitution, it is possible to apply a turn-on control to the respective light emitting diodes LD belonging to the group (R1, L1) as a whole and, at the same time, it is possible to apply a turn-off control to the respective light emitting diodes LD belonging to the group (R1, L1) as a whole when necessary. The same goes for the respective light emitting diodes LD belonging to other groups (R1, L2), (R1, L3), . . . , (R4, L4).

Although not shown in the drawing, on the back surface of the insulation substrate IBD of the backlight BL, the display control circuit 100, the memory 110 and an inverter 120 shown in FIG. 2 are arranged.

### (Driving of Liquid Crystal Display Panel PNL)

This embodiment adopts an FBI (Flexible Black Insertion) method for performing display driving of the liquid crystal display panel PNL. The display control circuit 100 executes the image processing based on the FBI method using image data inputted from the image processing engine 130 which constitutes an external system. Here, the summary of the FBI method is explained.

The liquid crystal display device is a holding-type display device which holds image data to be displayed until a next frame. Accordingly, in performing a motion picture display, so-called motion picture blurring (a phenomenon in which a periphery of a moving object is blurred) is liable to be generated. Various countermeasures have been developed for obviating such motion picture blurring. As a typical control method, a so-called twofold speed drive control where a display frame having a period of 60 Hz is driven at 120 Hz is named. The FBI method is one type of such a twofold speed drive control. In the FBI method, a period of each frame of image data inputted to the liquid crystal display panel from an external system is time-sequentially divided in two, for example, thus forming two image data having different grayscales which are referred to as a bright field and a dark field, and continuously performing a display based on the image data. That is, the image data from the external system is changed to image data having a grayscale higher than a grayscale of the image data from the external system in the bright field, and the image data from the external system is changed to image data having a grayscale lower than the grayscale of the image data from the external system in the dark field. To be more specific, the image data exhibits a characteristic that brightness is changed on a low grayscale side and a totally white display is performed on a high grayscale side in the bright field, and a characteristic that a totally black display is performed on a low grayscale side and brightness is changed on a high grayscale side in the dark field. When the image data in the bright field and the image data in the dark field are integrated with respect to time, a display similar to the display having the grayscale of the image data from the external system is obtained (see JP-A-2006-343706 (corresponding US patent publication US 2006/0256141 A1) (patent document 2) with respect to the FBI method). This FBI method can eliminate motion picture blurring without lowering display brightness.

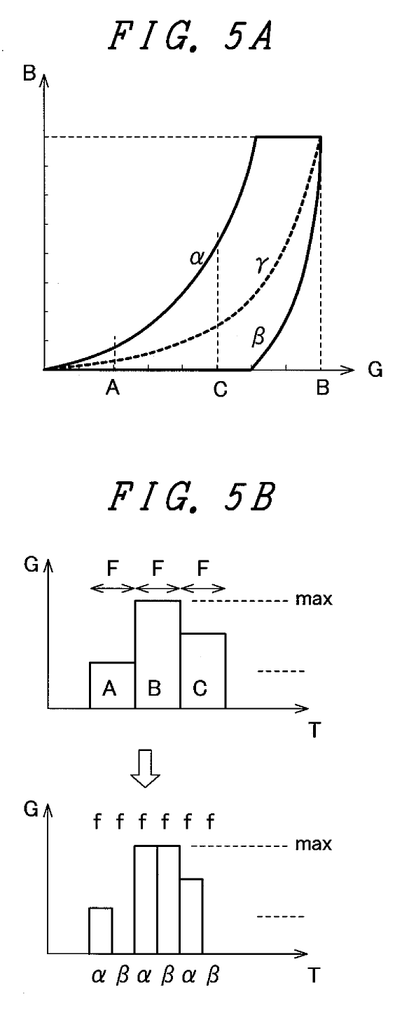

FIG. 5A is a correlation graph showing the relationship between the grayscale G of the image data (taken on an axis of abscissas) and brightness B which the liquid crystal display panel PNL displays (taken on an axis of ordinates).

In the graph, symbol γ indicates a characteristic of the image data outputted from the external system. Symbols α and β respectively indicate a characteristic of the image data in the bright field and a characteristic of the image data in the dark field obtained by processing using the FBI method.

The display control circuit 100 converts the grayscale of the image data inputted from the external system having the characteristic γ into the grayscale of the image data in the bright field (characteristic α) and the grayscale of the image data in the dark field (characteristic β), and outputs the image data of these grayscales to the liquid crystal display panel PNL as video signals which constitute display drive signals SS.

FIG. 5B shows one example of an image which is subject to the grayscale conversion based on the FBL method. A graph on an upper part of FIG. 5B shows input data from the external system with respect to a certain pixel, wherein time (T) is taken on an axis of abscissas and grayscale (G) is taken on an axis of ordinates. A graph on a lower part of FIG. 5B indicates display data outputted to the liquid crystal display panel PNL after being processed by the FBI method.

In this example, as shown in the graph on the upper part of FIG. 5B, assume that the image data is inputted in order of the data A having the low grayscale, the data B having the high grayscale and the data C having the intermediate grayscale. The input data in FIG. 5B is given the same symbols used in FIG. 5A.

In the processing based on the FBI method, 1 frame (F) of the inputted image data is divided into 2 fields “f”. With respect to two divided fields “f”, the video signal in the bright field whose characteristic is converted into the characteristic α in FIG. 5A is displayed in the first field α, and a video signal in the dark field whose characteristic is converted into the characteristic β is displayed in the next field β.

For example, with respect to data A, the input data (characteristic γ) is data having the low grayscale and hence, according to the correlation graph shown in FIG. 5A, the characteristic α for the bright frame exhibits brightness to some extent, and the characteristic β for the dark frame exhibits brightness of 0. Accordingly, the grayscale of a degree indicated in the lower part of FIG. 5B is outputted in the field α for the bright frame as the display data, and the display grayscale to be outputted in the field β for the dark frame becomes 0. In the same manner, with respect to data B, the input data (characteristic γ) exhibits the maximum grayscale and hence, the display data is outputted with the maximum grayscale in both of the field α for the bright frame and the field β for the dark frame. With respect to data C, input data (characteristic γ) exhibits the intermediate grayscale and hence, display data is outputted with grayscale corresponding to the characteristic α in the field α for the bright frame and with grayscale corresponding to the characteristic β in the field β for the dark frame respectively.

In this manner, with respect to each frame F in which the image data is inputted, the characteristic of the inputted image data is converted into the bright field characteristic α and the dark field characteristic β defined in FIG. 5A and hence, the bright field and the dark field are alternately displayed on the liquid crystal display panel PNL. By integrating the image data of bright field and the image data of the dark field with respect to time, the brightness of the integrated image data to be displayed becomes substantially equal to the brightness of image data having the characteristic γ. With such processing of the image data, data can be displayed at a twofold speed without lowering brightness thus reducing motion picture blurring. Data on the correlation graph shown in FIG. 5A is stored in the memory 110 and is used by the display control circuit 100 at the time of performing the FBI processing. The relationship between the grayscales G and the brightnesses B of the respective characteristics is not limited to values described in the correlation graph shown in FIG. 5A, and the relationship may be corrected corresponding to the display characteristic provided that the bright frame characteristic and the dark frame characteristic are maintained.

In this embodiment, the twofold speed control which changes the period of the display frame to 120 Hz is performed by the display control circuit 100. Image data of the display frame is inputted from the image processing engine 130 which constitutes the external system at a period of 60 Hz, and the display control circuit 100 time-sequentially divides (copies) the image data in two, and the respective grayscale information are converted into grayscale information for the bright field and grayscale information for the dark field so as to alternately perform a display thus enabling the display at the period of 120 Hz substantially. However, the present invention is not limited to such an embodiment. That is, even when a so-called two fold speed control of a frame interpolation method in which the image processing engine 130 prepares image data which performs interpolation between image data of the display frames having the period of 60 Hz by calculation and outputs the display frame having the period of 120 Hz is performed, the present invention is applicable to such a twofold speed control. In this case, the display control circuit 100, without dividing image data inputted from the image processing engine 130 based on the characteristic defined by FIG. 5A, directly converts image data inputted from the image processing engine 130 into the image in the bright frame or into the image in the dark frame in order of inputting thus alternately displaying the bright frame and the dark frame.

### (Driving of Backlight BL)

This embodiment adopts, as a drive method of the backlight BL, a local dimming method which divides a plurality of light emitting diodes LD into a plurality of groups and controls turning on/off of light emitting diodes LD for every group.

To be more specific, a light emitting quantity of the light emitting diodes LD of every group is adjusted in conformity with average grayscale data of video signals inputted to pixels of the liquid crystal display panel PNL in a region which overlaps with the light emitting diodes LD of each group. A light emitting quantity of the light emitting diodes LD can be finely set. For example, when a control is made with an adjustment quantity of 10 bits, the light emitting quantity can be obtained at 1024 stages. Grayscale data of a video signal inputted to the liquid crystal display panel PNL is controlled at 8 bits or 10 bits usually and hence, the grayscale of the light emitting diodes LD can be controlled substantially at the same level as the liquid crystal display panel PNL. Accordingly, the light emitting quantity of the light emitting diodes LD can be finely adjusted for every area thus increasing contrast of an image which can be displayed by the liquid crystal display panel PNL.

The liquid crystal display device of this embodiment, as described above, in the liquid crystal display panel PNL, converts the grayscale of the image data inputted from the external system, and divides each frame into the bright field and the dark field. The dark field is the field which corresponds to the characteristic β shown in FIG. 5A, and exhibits low brightness compared to the characteristic γ at all grayscales, and the dark field often exhibits the brightness which is substantially 0 or close to 0 on the lower grayscale side as shown in the drawing.

In this embodiment which repeats the display of the bright field and the dark field, the number of pixels whose display grayscales become 0 in the liquid crystal display panel PNL is inevitably increased. Accordingly, it is possible to increase the number of the light emitting diodes LD to be turned off and the number of turn-off times of such light emitting diodes LD thus reducing power consumption of the backlight BL more efficiently.

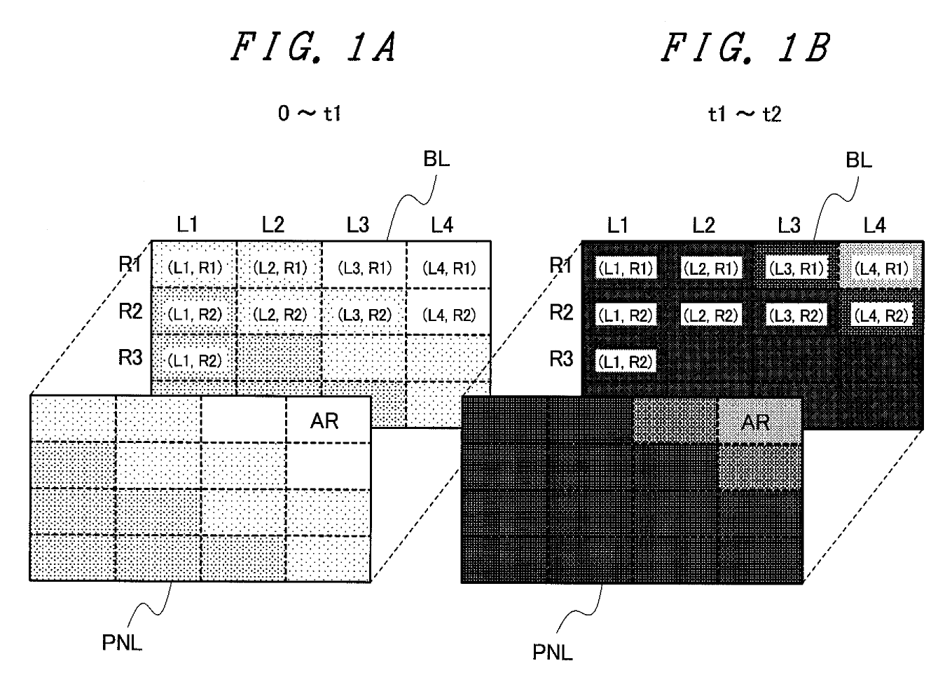

Here, FIG. 1 shows an example of a state of the bright field (FIG. 1(a)) and a state of a bright field (FIG. 1(b)) with respect to the liquid crystal display panel PNL and the backlight BL as a whole.

The backlight BL includes, as shown in FIG. 3, a plurality of light emitting diodes LD which is arranged in a matrix array, and the respective light emitting diodes LD have turning on/off thereof independently controlled for every group. In FIG. 1, the respective light emitting diodes are not shown in the drawing, and groups (R1, L1), (R1, L2), (R1, L3), (R1, L4), (R2, L1), (R2, L2), . . . , (R4, L2), (R4, L3), (R4, L4) which partition regions in which the respective light emitting diodes are arranged are shown. Further, the liquid crystal display panel PNL has the display region AR thereof partitioned into regions corresponding to (overlapping with) the respective groups of the backlight BL by a dotted line.

Further, in the display region AR of the liquid crystal display panel PNL shown in FIG. 1, image data inputted from the external system is displayed. To facilitate the explanation, the image data is described by taking an image in which brightness is low at a left lower portion of the display region AR and the brightness is high at a right upper portion of the display region AR as an example. Further, in FIG. 1, although the brightness is changed from the left lower portion to the right upper portion of the display region AR in a step-like manner, in an actual operation, a gradation display which gradually increases brightness in a non-step manner is assumed. Here, to facilitate the understanding of the explanation, the display grayscale within the region of each group is averaged.

As shown in FIG. 1(a) and FIG. 1(b), a light emitting quantity of the light emitting diodes in every group of the backlight BL is controlled corresponding to an average grayscale of every group of the liquid crystal display panel PNL.

For example, in the display of the dark field of the liquid crystal display panel PNL shown in FIG. 1(b), in the regions other than groups (L3, R1), (L4, R1), (L4, R2) of the backlight BL, a video signal to regions of the liquid crystal display panel PNL corresponding to the regions of the backlight BL has the grayscale of 0 and hence, the light emitting diodes are turned off. The light emitting diodes belonging to the groups (L3, R1), (L4, R1), (L4, R2) are turned on corresponding to video signals to the regions of the liquid crystal display panel PNL corresponding to the groups (L3, R1), (L4, R1), (L4, R2).

The manner of operation of the liquid crystal display device of this embodiment is explained in detail and more specifically by taking one pixel as an example hereinafter.

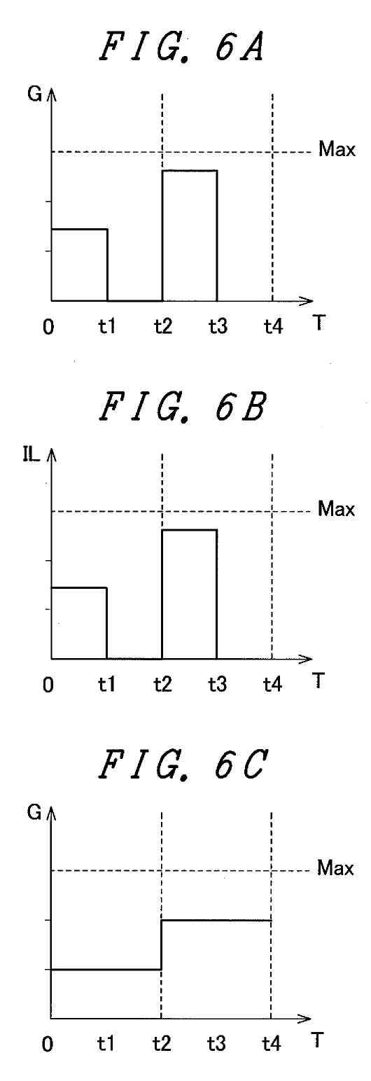

FIG. 6A to FIG. 6C are directed to one arbitrary pixel of the liquid crystal display panel PNL, wherein FIG. 6A is a graph showing a grayscale (G) of a video signal supplied to the liquid crystal display panel PNL from the display control circuit 100, FIG. 6B is a graph showing brightness (turn-on state) (IL) of the light emitting diode LD which corresponds to (or overlaps with) the pixel, and FIG. 6C is a graph showing grayscale (G) of image data outputted to the display control circuit 100 from the image processing engine 130. In the respective graphs, two frame periods are taken on an axis of abscissas, wherein time from 0 to t2 forms a beginning frame and time from t2 to t4 forms a next frame. In this embodiment, the grayscale conversion is performed by the FBI method and hence, in the beginning frame, the display of the bright field is performed during the time from 0 to t1 and the display of the dark field is performed during the time from t1 to t2, while in the next frame, the display of the bright field is performed during the time from t2 to t3, and the display of the dark field is performed during the time from t3 to t4.

First of all, as shown in FIG. 6C, with respect to the image data outputted to a certain pixel in the liquid crystal display panel PNL from the external system, assume a case in which the image data is displayed at the grayscale approximately ⅓ of the maximum grayscale during the time from 0 to t2, and the image data is displayed at the grayscale approximately ⅔ of the maximum grayscale during the time from t2 to t4. In this case, driving of the pixels in the liquid crystal display panel PNL is performed by conversion based on the FBI method and hence, the display device is driven at the grayscales shown in FIG. 6A in accordance with the correlation graph shown in FIG. 5A. That is, the grayscale becomes 0 in the dark field during the time from t1 to t2 and during the time from t3 to t4.

Then, as shown in FIG. 6B, the light emitting diode LD is turned on during the bright frame period and is turned off during the dark frame period. Further, the light emitting diode LD during the bright frame has brightness (luminance) IL thereof adjusted corresponding to the input grayscale.

The corresponding pixels in the liquid crystal display panel PNL, when the input grayscale is 0, exert no influence on the display of the liquid crystal display panel PNL even when the light emitting diodes LD are turned off. These pixels rather have an effect of enhancing the contrast of the display of the liquid crystal display panel PNL. In this manner, by increasing the period during which the light emitting diodes LD are turned off and the period during which the light is emitted at the low brightness, it is possible to reduce the power consumption of the backlight BL.

### COMPARISON EXAMPLE

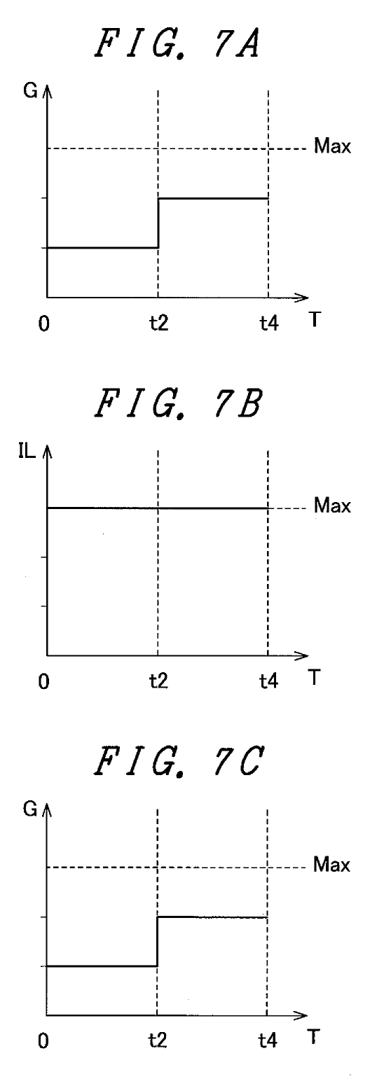

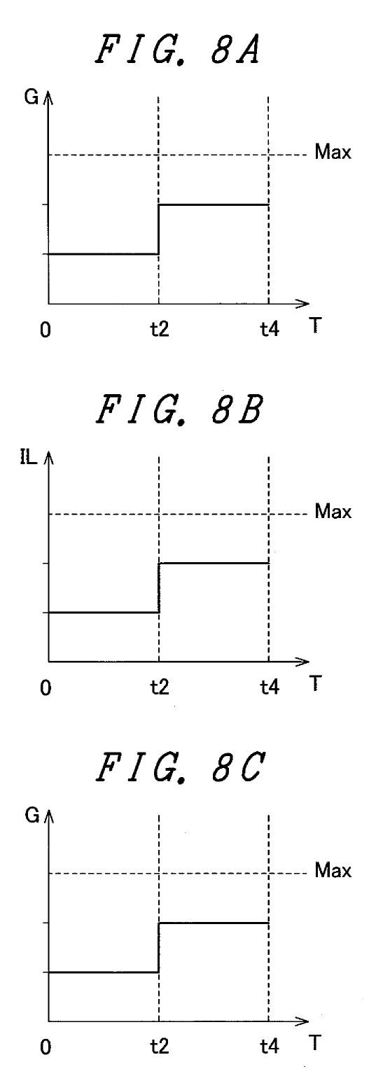

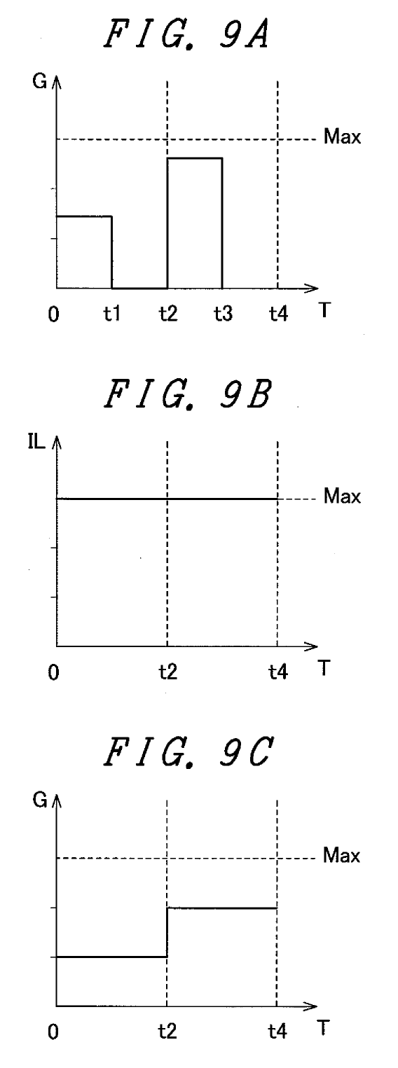

FIG. 7 to FIG. 9 respectively show an example in which the combination of the drive method of the liquid crystal display panel and the drive method of the backlight is exchanged with the combination of the above-mentioned example, and correspond to FIG. 6. Graphs shown in FIG. 7C, FIG. 8C and FIG. 9C indicate the grayscale of one arbitrary pixel of the image data inputted to the display control circuit 100 from the image processing engine 130. To facilitate the comparison, these graphs are in the same form as the graph shown in FIG. 6C.

FIG. 7A to FIG. 7C show a usual drive method which adopts neither the above-mentioned local dimming method nor the above-mentioned FIB method. As shown in FIG. 7 A to FIG. 7C, the backlight BL is always in an ON state during time from 0 to t4 (FIG. 7B). Accordingly, lowering of the power consumption of the backlight BL is not expected.

FIG. 8A to FIG. 8C show a usual drive method which adopts a local dimming method but does not adopt the FIB method. As shown in FIG. 8, the backlight BL changes brightness corresponding to a display grayscale and hence, slight lowering of power consumption is expected. However, the backlight is always in an ON state and hence, remarkable lowering of power consumption cannot be expected.

FIG. 9A to FIG. 9C show an example which adopts the FBI method but does not adopt the local dimming method. In FIG. 9, a period from t1 to t2 and a period from t3 to t4 are dark frames and hence, grayscales are 0. However, the backlight BL is always in an ON state and hence, lowering of power consumption of the backlight BL cannot be not expected.

### Embodiment 2

In the above-mentioned embodiment, for the sake of brevity, the partitioning number or dividing number of light emitting regions of the backlight BL is set to 16 (4×4). However, it may be possible to increase the dividing number so as to narrow the divided region in which the light emitting diodes can be collectively turned off. By adopting such constitution, the number of divided regions where the light emitting diodes can be turned off can be increased, and the power consumption of the backlight BL can be reduced corresponding to the increase of the divided regions.

Although the present invention has been explained in conjunction with embodiments, the constitutions explained in the respective embodiments heretofore are merely examples, and various modifications can be suitably made without departing from the technical concept of the present invention. Further, the constitutions explained in conjunction with the respective embodiments may be combined unless the constitutions do not contradict each other.

What is claimed is:

1. A liquid crystal display device comprising:
a liquid crystal display panel which includes a display region formed of a mass of a plurality of pixels;
a backlight which has a plurality of light sources receiving a lighting control independently, and has a region thereof where the light sources are mounted partitioned into a plurality of lighting regions; and
a control circuit which converts image data inputted from the outside into a video signal to be supplied to the liquid crystal display panel and performs the lighting control of the backlight, wherein
the control circuit forms a first frame in which image data having a grayscale higher than a grayscale of image data to be displayed is formed and a second frame in which image data having a grayscale lower than a grayscale of the image data to be displayed are formed, and alternately displays the image data in the first frame and the image data in the second frame, and
the backlight performs the lighting control for every lighting region of the backlight in conformity with a display content of the liquid crystal display panel.

2. A liquid crystal display device according to claim 1, wherein the light sources of the backlight are light emitting diodes.

3. A liquid crystal display device according to claim 2, wherein the light emitting diodes are arranged in a matrix array at positions where the light emitting diodes overlap with the liquid crystal display panel.

4. A liquid crystal display device according to claim 2, wherein the plurality of lighting regions is partitioned in a check pattern on a substrate of the backlight.

5. A liquid crystal display device according to claim 2, wherein the plurality of light emitting diodes is arranged in the lighting regions.

6. A liquid crystal display device according to claim 1, wherein brightness of the light source of the backlight is controlled in conformity with input grayscales of the respective image data in the first frame and the second frame.
